(19) United States
(12) Patent Application Publication
(10) Pub. No.: US 2025/0232268 A1
(43) Pub. Date: Jul. 17, 2025

(54) BATTERY MANAGER

(71) Applicant: SUBARU CORPORATION, Tokyo (JP)

(72) Inventor: Hideaki KATO, Tokyo (JP)

(21) Appl. No.: 19/170,119

(22) Filed: Apr. 4, 2025

Related U.S. Application Data
(63) Continuation of application No. PCT/JP2023/034953, filed on Sep. 26, 2023.

(51) Int. Cl. G06Q 10/20; B60L 58/12; G07C 5/00

(52) U.S. Cl. CPC G06Q 10/20; B60L 58/12; G07C 5/004; G07C 5/008

(57) ABSTRACT

A battery manager includes processing circuitry and communication circuitry. The processing circuitry is configured to manage data on batteries to be used in battery-replaceable vehicles. The batteries include a first battery and a second battery. The battery-replaceable vehicles include a first vehicle and a second vehicle to each of which the battery manager is to be applied. The processing circuitry is configured to determine whether the first battery of the first vehicle scheduled for battery replacement in a first battery station is usable in the second vehicle, based on a remaining state of charge of the first battery before the battery replacement. When the first battery is usable in the second vehicle, the communication circuitry is configured to transmit, to the second vehicle, a notification indicating that the second battery of the second vehicle is replaceable with the first battery in the first battery station.

### CROSS-REFERENCE TO RELATED APPLICATIONS

This application is continuation of International Application No. PCT/JP2023/034953, filed on Sep. 26, 2023, the entire contents of which are hereby incorporated by reference.

### BACKGROUND

The disclosure relates to a battery manager that manages batteries for battery-replaceable vehicles.

Some vehicles such as electric vehicles are equipped with a replaceable battery. The battery of such a vehicle is replaced in a battery station. For example, International Publication No. WO 2019/163573 discloses a system of guiding a user to a battery station where a battery of a vehicle having a low remaining state of charge is replaceable with a charged battery.

### SUMMARY

An aspect of the disclosure provides a battery manager including processing circuitry and communication circuitry. The processing circuitry is configured to manage data on batteries to be used in battery-replaceable vehicles. The batteries include a first battery and a second battery. The battery-replaceable vehicles include a first vehicle and a second vehicle to each of which the battery manager is to be applied. The processing circuitry is configured to determine whether the first battery of the first vehicle scheduled for battery replacement in a first battery station is usable in the second vehicle, based on a remaining state of charge of the first battery before the battery replacement. When the first battery is usable in the second vehicle, the communication circuitry is configured to transmit, to the second vehicle, a notification indicating that the second battery of the second vehicle is replaceable with the first battery in the first battery station. The processing circuitry is further configured to check whether a second battery station is available for the battery replacement for the first vehicle. When the second battery station is available, the communication circuitry is configured to request the first vehicle to change a battery replacement location from the first battery station to the second battery station. The communication circuitry is configured to receive a notification indicating acceptance of changing the battery replacement location from the first vehicle. When receiving the notification indicating the acceptance of changing the battery replacement location from the first vehicle, the communication circuitry is configured to transmit, to the second vehicle, a notification indicating that the second battery is replaceable with the first battery in the second battery station.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a block diagram illustrating a configuration example of a battery management system according to one example embodiment of the disclosure.

FIG. 2 is a block diagram illustrating a configuration example of an in-vehicle apparatus illustrated in FIG. 1.

FIG. 3 is a block diagram illustrating a configuration example of a battery manager illustrated in FIG. 1.

FIG. 4 is an explanatory table illustrating a configuration example of management data illustrated in FIG. 3.

FIG. 5 is an explanatory diagram illustrating an operation example of the battery management system illustrated in FIG. 1.

FIG. 6 is a sequence diagram illustrating the operation example illustrated in FIG. 5.

FIG. 7A is an explanatory table illustrating an example of the management data in the operation example illustrated in FIG. 5.

FIG. 7B is another explanatory table illustrating the example of the management data in the operation example illustrated in FIG. 5.

FIG. 7C is still another explanatory table illustrating the example of the management data in the operation example illustrated in FIG. 5.

FIG. 8 is an explanatory diagram illustrating another operation example of the battery management system illustrated in FIG. 1.

FIG. 9A is a sequence diagram illustrating the other operation example illustrated in FIG. 8.

FIG. 9B is another sequence diagram illustrating the other operation example illustrated in FIG. 8.

FIG. 9C is still another sequence diagram illustrating the other operation example illustrated in FIG. 8.

FIG. 10A is an explanatory table illustrating an example of the management data in the other operation example illustrated in FIG. 8.

FIG. 10B is another explanatory table illustrating the example of the management data in the other operation example illustrated in FIG. 8.

FIG. 10C is still another explanatory table illustrating the example of the management data in the other operation example illustrated in FIG. 8.

FIG. 10D is a further explanatory table illustrating the example of the management data in the other operation example illustrated in FIG. 8.

FIG. 10E is a further explanatory table illustrating the example of the management data in the other operation example illustrated in FIG. 8.

FIG. 11 is a sequence diagram illustrating an operation example of a battery management system according to a modification example.

### DETAILED DESCRIPTION

A typical approach to making battery replacement for a large number of vehicles involves storing a large number of batteries in a battery station. This approach, however, can increase a dwell time of the batteries in the battery station. Accordingly, it is desired to shorten the dwell time of the batteries in the battery station.

It is desirable to shorten a dwell time of batteries in a battery station.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### Example Embodiment

### Configuration Example

FIG. 1 illustrates a configuration example of a battery management system 1 including a battery manager according to an example embodiment of the disclosure. The battery management system 1 may include multiple vehicles 10, multiple battery stations 20, and a battery manager 30. In this example, the battery stations 20 and the battery manager 30 may be each coupled to the Internet to thereby allow for communication between the battery stations 20 and the battery manager 30. The multiple vehicles 10 may be each coupled to the Internet through wireless communication to thereby communicate with the battery manager 30.

The multiple vehicles 10 may be each an electric vehicle to be driven by electric power supplied from a battery 11 to be described later. The battery 11 may be attachable to and detachable from the vehicle 10. The battery 11 may be detached from or attached to the vehicle 10 in the battery station 20. The battery manager 30 manages data on batteries 11. For example, when a remaining state of charge (SOC) of the battery 11 of the vehicle 10 becomes low, the vehicle 10 may communicate with the battery manager 30 to check in which battery station 20 the battery 11 is replaceable with another battery 11 usable in the vehicle 10 and to make a reservation for replacement of the battery 11. The battery manager 30 may manage data on batteries 11 already stocked in the battery station 20 and data on batteries 11 scheduled to be stocked in the battery station 20. Accordingly, for example, when the vehicle 10 (a vehicle 10B to be described later) makes a reservation for the replacement of the battery 11, the battery management system 1 may allow another vehicle 10 (a vehicle 10C to be described later) to make a reservation for use of the battery 11 of the vehicle 10B used prior to the replacement.

The vehicle 10 may include the battery 11 and an in-vehicle apparatus 12. The battery 11 may be attachable to and detachable from the vehicle 10. The battery 11 may be configured to supply the charged electric power to the vehicle 10. The vehicle 10 may be driven by operating a motor by the electric power supplied from the battery. The in-vehicle apparatus 12 may be an electronic apparatus installed in the vehicle 10.

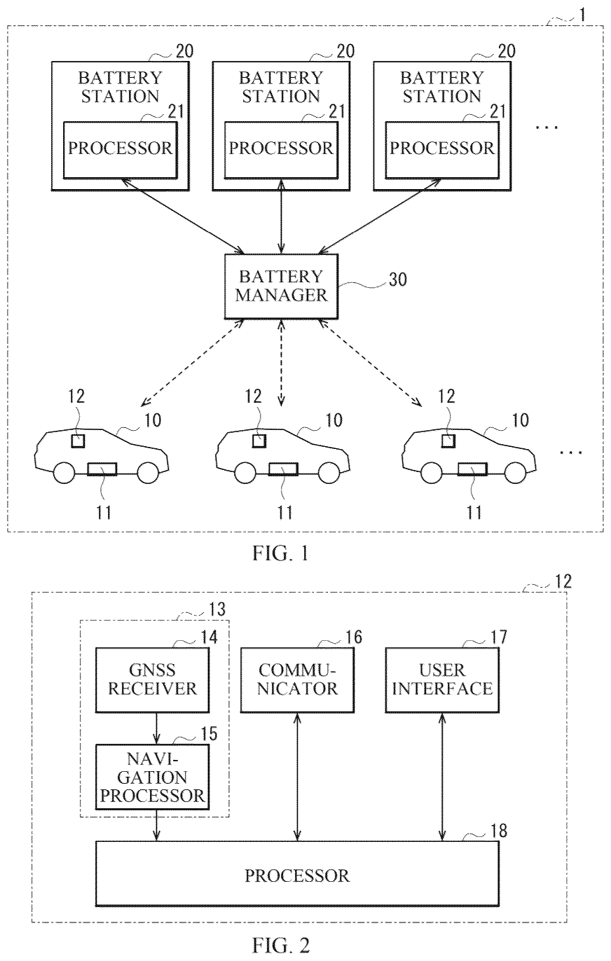

FIG. 2 illustrates a configuration example of the in-vehicle apparatus 12. The in-vehicle apparatus 12 may include a navigator 13, a communicator 16, a user interface 17, and a processor 18.

The navigator 13 may be configured to determine a route (a planned travel route) to a destination on which the vehicle 10 is to travel. The navigator 13 may also be configured to provide information to a driver who drives the vehicle 10 to thereby guide the vehicle 10 along the determined route. The navigator 13 may include a global navigation satellite system (GNSS) receiver 14 and a navigation processor 15. The GNSS receiver 14 may be configured to acquire a position of the vehicle 10 on the ground using a GNSS. Non-limiting examples of the GNSS include Global Positioning System (GPS) and any other system having positioning functionality. The navigation processor 15 may determine the planned travel route of the vehicle 10 using a map database including data on a road map. In some embodiments, the navigation processor 15 may include a storage that holds the map database and determine the planned travel route using the map database held in the storage. In some embodiments, the navigation processor 15 may determine the planned travel route through communication by the communicator 16 with a network server that holds the map database. In some embodiments, the navigator 13 may be configured to determine the planned travel route to the destination, based on information on the destination inputted by the driver operating the user interface 17, and provide information on the determined route to the driver through the user interface 17.

The communicator 16 may be configured to communicate with a base station through mobile communication such as 4th generation (4G) mobile communication or 5th generation (5G) mobile communication. The communicator 16 may be configured to communicate via the base station with the battery manager 30 coupled to the Internet.

The user interface 17 may include a device such as a display panel, a touch panel, or various kinds of buttons. The user interface 17 may be configured to receive an operational input from a user such as the driver and provide information to the user.

The processor 18 may include, for example, one or more processors and one or more memories. The processor 18 may be configured to control respective operations of the navigator 13, the communicator 16, and the user interface 17.

The multiple battery stations 20 may be each a facility for the replacement of the battery 11 of the vehicle 10. The battery stations 20 may be each provided with a processor 21 that is coupled to a network such as the Internet. When the battery 11 of the vehicle 10 has been replaced in the battery station 20, the processor 21 may be configured to supply data on the replacement to the battery manager 30 via the Internet.

The battery manager 30 may be configured to manage the data on the batteries 11. In some embodiments, the battery manager 30 may be configured to manage the data on the batteries 11 already stocked in the battery station 20 and the data on the batteries 11 scheduled to be stocked in the battery station 20.

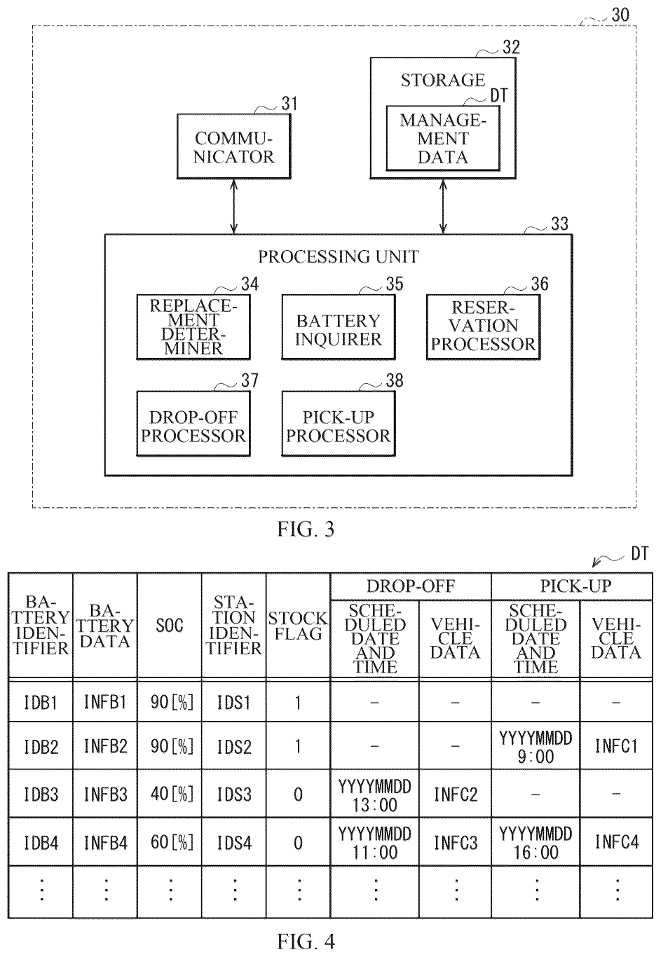

FIG. 3 illustrates a configuration example of the battery manager 30. The battery manager 30 includes a communicator 31, a storage 32, and a processing unit 33.

The communicator 31 may be configured to be coupled to a network such as the Internet to thereby communicate with the multiple vehicles 10 and the processors 21 of the multiple battery stations 20.

The storage 32 may include a storage device such as a hard disk drive (HDD) or a solid-state drive (SSD). The storage 32 may be configured to hold management data DT on the batteries 11.

FIG. 4 illustrates an example of the management data DT. The management data DT may include data on: a battery identifier, battery data, and a state of charge (SOC) of the battery 11; a station identifier of the battery station 20; a stock flag of the battery 11; scheduled drop-off date and time of the battery 11; data on a vehicle to drop off the battery 11 (hereinafter, referred to as drop-off vehicle data); scheduled pick-up date and time of the battery 11; and data on a vehicle to pick up the battery 11 (hereinafter, referred to as pick-up vehicle data). The battery identifier may refer to an identifier of the battery 11. The battery data may include data on characteristics and specifications of the battery 11, such as a maximum charge amount of the battery 11. The SOC may refer to a charge rate of the battery 11. When the battery 11 is already stocked in the battery station 20, the SOC may refer to the charge rate of the battery 11. When the battery 11 is scheduled to be stocked in the battery station 20, the SOC may refer to an estimated value of the SOC as of scheduled date and time for the battery 11 to be dropped off in the battery station 20. The station identifier may refer to an identifier of the battery station 20. The stock flag may indicate whether the battery 11 is already stocked in the battery station 20. In this example, a stock flag of “1” may indicate that the battery 11 is already stocked in the battery station 20, while a stock flag of “0” may indicate that the battery 11 is scheduled to be stocked in the battery station 20. The scheduled drop-off date and time of the battery 11 may refer to the scheduled date and time for the battery 11 to be dropped off in the battery station 20. The drop-off vehicle data may refer to data on the vehicle 10 whose battery 11 is to be dropped off. The drop-off vehicle data may include data such as an identifier of the vehicle 10, address data on the vehicle 10 to be used in communication, or characteristics and specifications of the vehicle 10. The drop-off vehicle data may include data on specific power consumption of the vehicle 10. The specific power consumption of the vehicle 10 may refer to, for example, a distance [km] over which the vehicle 10 is travelable with electric power of 1 kWh. The scheduled pick-up date and time of the battery 11 may refer to scheduled date and time for the battery 11 to be picked up from the battery station 20. The pick-up vehicle data may refer to data on the vehicle 10 to pick up the battery 11. The pick-up vehicle data may include data such as the identifier of the vehicle 10, the address data on the vehicle 10 to be used in communication, or the characteristics and specifications of the vehicle 10.

In the management data DT illustrated in FIG. 4, for example, a record in the first row may indicate data on the battery 11 having a battery identifier of “IDB1”. In this record, the station identifier may be “IDS1”, and the stock flag may be “1”, meaning that the battery 11 having the battery identifier of “IDB1” is already stocked in the battery station 20 having the station identifier of “IDS1”. The SOC of this battery 11 may be 90%.

For example, a record in the second row may indicate data on the battery 11 having a battery identifier of “IDB2”. In this record, the station identifier may be “IDS2”, and the stock flag may be “1”, meaning that the battery 11 having the battery identifier of “IDB2” is already stocked in the battery station 20 having the station identifier of “IDS2”. The SOC of this battery 11 may be 90%. In this example, the scheduled pick-up date and time may be “YYYYMMDD, 9:00”, and the pick-up vehicle data may be “INFC1”, where “YYYYMMDD” may denote a year, a month, and a date. Accordingly, the battery 11 having the battery identifier of “IDB2” may be scheduled to be picked up from the battery station 20 having the station identifier of “IDS2” by being attached to the vehicle 10 having the vehicle data of “INFC1” on the scheduled pick-up date and time.

For example, a record in the third row may indicate data on the battery 11 having a battery identifier of “IDB3”. In this record, the stock flag may be “0”, meaning that the battery 11 having the battery identifier of “IDB3” has not been stocked in the battery station 20 yet. In this example, the scheduled drop-off date and time may be “YYYYMMDD, 13:00”, the drop-off vehicle data may be “INFC2”, and the station identifier may be “IDS3”. Accordingly, the battery 11 having the battery identifier of “IDB3” may be scheduled to be dropped off in the battery station 20 having the station identifier of “IDS3” by being detached from the vehicle 10 having the vehicle data of “INFC2” on the scheduled drop-off date and time. The estimated value of the SOC at the time of the drop off of this battery 11 may be 40%.

For example, a record in the fourth row may indicate data on the battery 11 having a battery identifier of “IDB4”. In this record, the stock flag may be “0”, meaning that the battery 11 having the battery identifier of “IDB4” has not been stocked in the battery station 20 yet. In this example, the scheduled drop-off date and time may be “YYYYMMDD, 11:00”, the drop-off vehicle data may be “INFC3”, and the station identifier may be “IDS4”. Accordingly, the battery 11 having the battery identifier of “IDB4” may be scheduled to be dropped off in the battery station 20 having the station identifier of “IDS4” by being detached from the vehicle 10 having the vehicle data of “INFC3” on the scheduled drop-off date and time. The estimated value of the SOC at the time of the drop off of this battery 11 may be 60%. Further, in this example, the scheduled pick-up date and time may be “YYYYMMDD, 16:00”, and the pick-up vehicle data may be “INFC4”. Accordingly, the battery 11 having the battery identifier of “IDB4” may be scheduled to be picked up from the battery station 20 having the station identifier of “IDS4” by being attached to the vehicle 10 having the vehicle data of “INFC4” on the scheduled pick-up date and time.

The processing unit 33 may include, for example, one or more processors and one or more memories. The processing unit 33 may be configured to perform processing by executing a program. The processing unit 33 may include a replacement determiner 34, a battery inquirer 35, a reservation processor 36, a drop-off processor 37, and a pick-up processor 38.

The replacement determiner 34 may be configured to determine whether to replace the battery 11 of the vehicle 10, based on data supplied from the vehicle 10.

If the battery 11 of the vehicle 10 is to be replaced, the battery inquirer 35 may be configured to check whether the battery 11 already stocked in the battery station 20 or the battery 11 scheduled to be stocked in the battery station 20 is usable in the vehicle 10, based on the management data DT.

The reservation processor 36 may be configured to receive a reservation for the battery replacement and update the management data DT.

When the battery 11 is dropped off in the battery station 20 by being detached from the vehicle 10 in the battery station 20, the drop-off processor 37 may be configured to update the management data DT.

When the battery 11 is picked up from the battery station 20 by being attached to the vehicle 10 in the battery station 20, the pick-up processor 38 may be configured to update the management data DT.

In one embodiment, the processing unit 33 may serve as “processing circuitry”. In one embodiment, the communicator 31 may serve as “communication circuitry”. In one embodiment, the vehicle 10 may serve as a “first vehicle” and a “second vehicle”. In one embodiment, the battery 11 may serve as a “first battery” and a “second battery”. In one embodiment, the battery station 20 may serve as a “first battery station”.

### Operation and Example Workings

An operation and example workings of the battery management system 1 according to the example embodiment will now be described.

### Overview of Overall Operation

First, the operation of the battery management system 1 will be described with reference to FIGS. 1 and 3. The battery manager 30 may manage the data on the batteries 11 already stocked in the battery station 20 and the data on the batteries 11 scheduled to be stocked in the battery station 20. For example, when the remaining SOC of the battery 11 of the vehicle 10 becomes low, the vehicle 10 may communicate with the battery manager 30. The replacement determiner 34 of the battery manager 30 may determine whether to replace the battery 11 of the vehicle 10, based on the data supplied from the vehicle 10. If the battery 11 of the vehicle 10 is to be replaced, the battery inquirer 35 of the battery manager 30 may check whether the battery 11 already stocked in the battery station 20 or the battery 11 scheduled to be stocked in the battery station 20 is usable in the vehicle 10, based on the management data DT. When the battery 11 of the vehicle 10 is determined to be replaced, the reservation processor 36 of the battery manager 30 may receive a reservation for the battery replacement and update the management data DT. Thereafter, upon arrival of the vehicle 10 at the battery station 20, the battery 11 may be detached from the vehicle 10 in the battery station 20. The drop-off processor 37 of the battery manager 30 may update the management data DT, based on the data from the processor 21 of the battery station 20. Thereafter, another battery 11 may be attached to the vehicle 10 in the battery station 20. The pick-up processor 38 of the battery manager 30 may update the management data DT, based on the data from the processor 21 of the battery station 20.

### Details of Operation

Hereinafter, some operation examples of the battery management system 1 will be described in detail by way of example.

### Operation Example E1

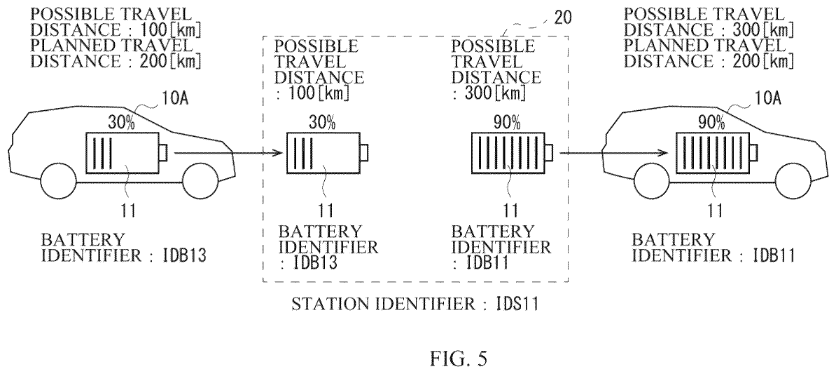

FIG. 5 illustrates an operation example E1 as an operation example of the battery management system 1. In FIG. 5, the battery 11 may be illustrated as a battery symbol indicating a remaining SOC.

In this example, the vehicle 10 (hereinafter, referred to as a “vehicle 10A”) may be traveling on a planned travel route toward a target point. The battery 11 of the vehicle 10A may have a battery identifier of “IDB13”, a remaining SOC of 30%, and a possible travel distance of 100 km. The vehicle 10A may plan to travel a distance (i.e., have a planned travel distance) to the target point of 200 km. Accordingly, the vehicle 10A may have a difficulty in reaching the target point using the current battery 11.

In this example, the battery station 20 having a station identifier of “IDS11” may be situated on the planned travel route of the vehicle 10A. The battery 11 having a battery identifier of “IDB11” may be stocked in this battery station 20. The battery 11 having the battery identifier of “IDB11” may have a remaining SOC of 90% and a possible travel distance of 300 km. If the battery 11 of the vehicle 10A is replaced with the battery 11 having the battery identifier of “IDB11” in the battery station 20, the vehicle 10A may be able to reach the target point.

Hereinafter, the operation of the battery management system 1 in such an example will be described.

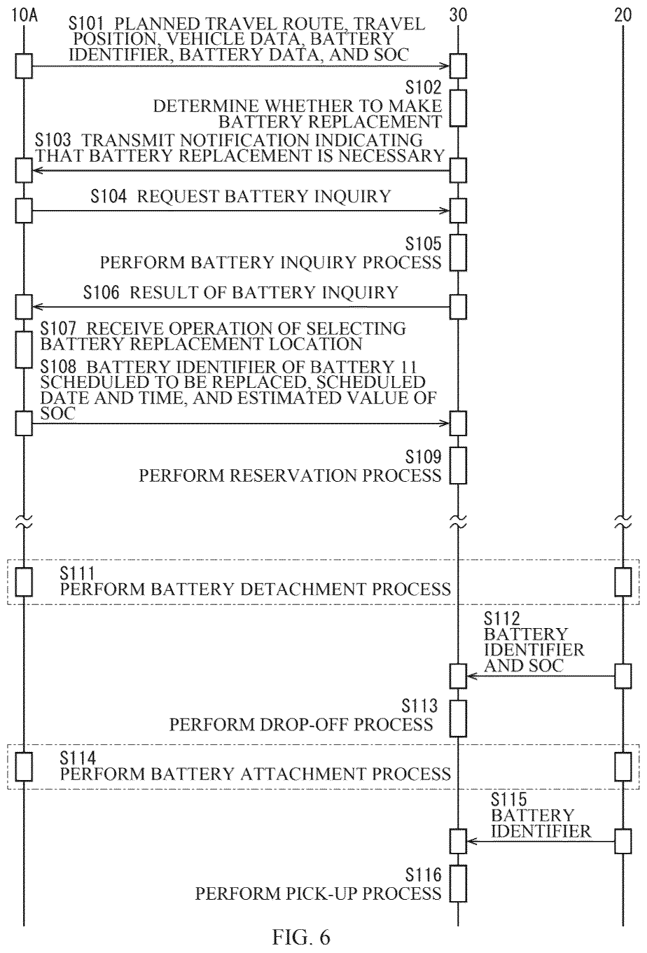

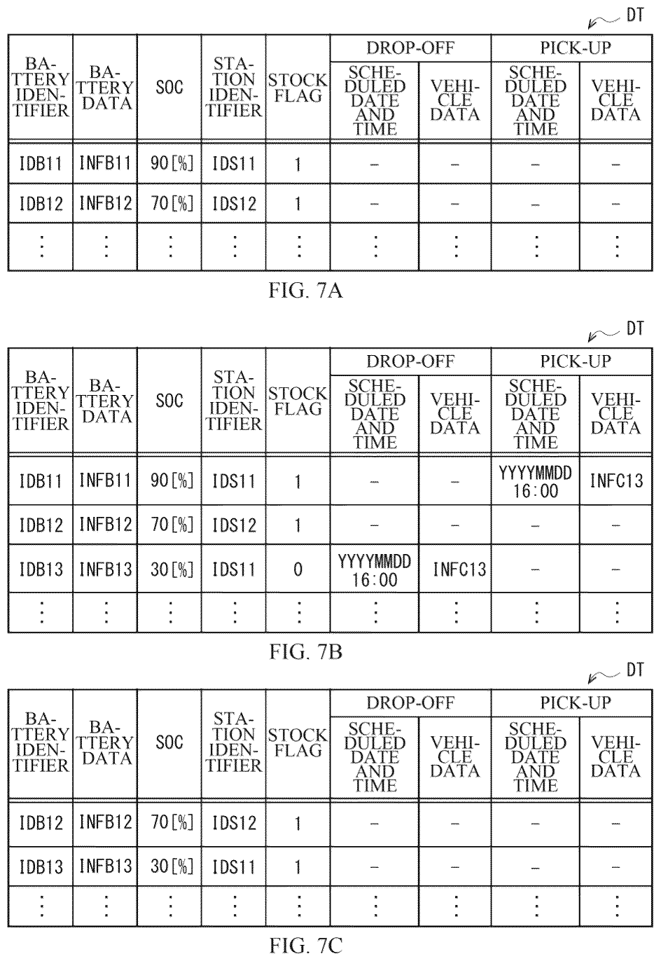

FIG. 6 illustrates an exemplary operation of the battery management system 1 in the operation example E1. FIGS. 7A to 7C each illustrate an example of the management data DT in the operation example E1.

First, the communicator 16 of the vehicle 10A may transmit data including the planned travel route of the vehicle 10A, a current travel position of the traveling vehicle 10A, vehicle data on the vehicle 10A, and a battery identifier of the battery 11 attached to the vehicle 10A, battery data on the battery 11 attached to the vehicle 10A, and an SOC of the battery 11 attached to the vehicle 10A, to the battery manager 30 in accordance with an instruction from the processor 18 (step S101). In some embodiments, the vehicle 10A may transmit such data in accordance with an instruction from the driver. In some embodiments, the vehicle 10A may transmit such data when the remaining SOC of the battery 11 of the vehicle 10A becomes less than or equal to a predetermined amount. The communicator 31 of the battery manager 30 may receive the data from the communicator 16.

Next, the replacement determiner 34 of the battery manager 30 may determine whether to make the battery replacement, based on the data received by the communicator 31 (step S102). In some embodiments, the replacement determiner 34 may calculate a remaining planned travel distance over which the vehicle 10A is to travel, based on the data on the planned travel route of the vehicle 10A and the travel position of the vehicle 10A. Further, the replacement determiner 34 may calculate the possible travel distance of the vehicle 10A, based on data on the maximum SOC of the battery 11 included in the battery data, the current SOC of the battery 11 of the vehicle 10A, and specific power consumption of the vehicle 10A included in the vehicle data on the vehicle 10A. Furthermore, the replacement determiner 34 may determine whether to make the battery replacement for the vehicle 10A by comparing the planned travel distance with the possible travel distance.

In the operation example E1 illustrated in FIG. 5, the possible travel distance of the vehicle 10A (100 km) may be shorter than the planned travel distance of the vehicle 10A (200 km). Accordingly, the replacement determiner 34 may determine that the battery replacement is to be made for the vehicle 10A.

Next, the communicator 31 of the battery manager 30 may transmit a notification indicating that the battery replacement is necessary, to the vehicle 10A in accordance with an instruction from the processing unit 33 (step S103). The communicator 16 of the vehicle 10A may receive the notification from the communicator 31.

Next, the communicator 16 of the vehicle 10A may transmit a request for battery inquiry to the battery manager 30 in accordance with an instruction from the processor 18 (step S104). In some embodiments, the processor 18 of the vehicle 10A may request the battery inquiry into searching the multiple battery stations 20 situated on the planned travel route for the battery 11 usable in the vehicle 10A. The communicator 31 of the battery manager 30 may receive the request for the battery inquiry from the communicator 16.

Next, the battery inquirer 35 of the battery manager 30 may perform a battery inquiry process (step S105). In some embodiments, the battery inquirer 35 may search the multiple battery stations 20 situated on the planned travel route of the vehicle 10A for the battery 11 usable in the vehicle 10A, based on the management data DT. For example, when the possible travel distance of the battery 11 is longer than the planned travel distance of the vehicle 10A, the battery inquirer 35 may determine that the battery 11 is usable in the vehicle 10A. In some embodiments, the usable battery 11 may be the battery 11 already stocked in the battery station 20. In some embodiments, the usable battery 11 may be the battery 11 scheduled to be stocked in the battery station 20 after being used in another vehicle 10.

Referring to FIG. 7A, for example, in the operation example E1, two batteries 11 in two respective battery stations 20 may be usable in the vehicle 10A. The battery 11 having the battery identifier of “IDB11” may be already stocked in the battery station 20 having the station identifier of “IDS11”, and have an SOC of 90%. The battery 11 having a battery identifier of “IDB12” may be already stocked in the battery station 20 having a station identifier of “IDS12”, and have an SOC of 70%. The two battery stations 20 may be situated on the planned travel route of the vehicle 10A.

Next, the communicator 31 of the battery manager 30 may transmit a result of the battery inquiry process in accordance with an instruction from the processing unit 33 (step S106). In this example, the communicator 31 may transmit data on the two battery stations 20 and the two batteries 11 that are illustrated in FIG. 7A. The communicator 16 of the vehicle 10A may receive the result of the battery inquiry process from the communicator 31.

Next, the user interface 17 of the vehicle 10A may receive an operation of selecting a battery replacement location in accordance with an instruction from the processor 18 (step S107). In some embodiments, the user interface 17 may display the data on the battery station 20 and the usable battery 11, included in the result of the battery inquiry process having been received by the communicator 16. For example, based on content displayed on the user interface 17, the driver may perform a selection operation of determining in which battery station 20 the battery 11 is to be replaced and selecting a desired battery station 20 for the replacement of the battery 11. The user interface 17 may receive the selection operation performed by the driver. By this selection operation, the battery station 20 for the battery replacement and the battery 11 to be attached to the vehicle 10A may be selected.

In the operation example E1, for example, the driver may perform the selection operation of selecting the battery station 20 having the station identifier of “IDS11” illustrated in FIG. 7A for the replacement of the battery 11. By this selection operation, the battery 11 having the battery identifier of “IDB11” and stocked in the battery station 20 having the station identifier of “IDS11” may be selected as the battery 11 to be used.

Next, the communicator 16 of the vehicle 10A may transmit data on the battery identifier of the selected battery 11, scheduled arrival date and time of the vehicle 10A at the selected battery station 20, and an estimated value of the SOC of the battery 11 being currently used in the vehicle 10A, to the battery manager 30 in accordance with an instruction from the processor 18 (step S108). The estimated value of the SOC may be an estimated value of the SOC at the time of the arrival of the vehicle 10A at the battery station 20, and may be calculated based on the current travel position of the vehicle 10A, a position of the battery station 20, a current SOC of the battery 11, and the specific power consumption of the vehicle 10A. The communicator 31 of the battery manager 30 may receive the data from the communicator 16.

Next, the reservation processor 36 of the battery manager 30 may perform a reservation process for the battery replacement (step S109). In some embodiments, the reservation processor 36 may update the management data DT, based on the data received by the communicator 31 in steps S101 and S108. For example, the reservation processor 36 may register scheduled pick-up date and time and pick-up vehicle data for the battery 11 scheduled to be attached to the vehicle 10A, in a record of this battery 11 in the management data DT. Further, the reservation processor 36 may register a new record of the battery 11 being used in the vehicle 10A, in the management data DT. Scheduled drop-off date and time and drop-off vehicle data for the battery 11 being used in the vehicle 10A may be registered in this record.

Referring to FIG. 7B, for example, in the operation example E1, the reservation processor 36 may register data on the scheduled pick-up date and time and the pick-up vehicle data, in the record of the battery 11 having the battery identifier of “IDB11” and scheduled to be attached to the vehicle 10A. In this example, the scheduled pick-up date and time may be “YYYYMMDD, 16:00”, and the pick-up vehicle data may be “INFC13”. This vehicle data may be related to the vehicle 10A.

Further, the reservation processor 36 may register a new record of the battery 11 having the battery identifier of “IDB13” and being used in the vehicle 10A, in the management data DT. The battery data on this battery 11 may be “INFB13”. The battery replacement for the vehicle 10A may be to be made in the battery station 20 having the station identifier of “IDS11” in which the battery 11 to be attached to the vehicle 10A is stocked. In this example, the scheduled drop-off date and time may be “YYYYMMDD, 16:00”, and the drop-off vehicle data may be “INFC13”.

In this way, the reservation for the battery replacement for the vehicle 10A may be made in the battery management system 1. Thereafter, the vehicle 10A may continue traveling along the planned travel route to arrive at the battery station 20 having the station identifier of “IDS11” in which the battery replacement is to be made.

In the battery station 20, for example, staff may operate the vehicle 10A and the processor 21 of the battery station 20. In accordance with the operation performed by the staff, the vehicle 10A and the processor 21 of the battery station 20 may perform a battery detachment process of detaching the battery 11 from the vehicle 10A (step S111). In this process, the processor 21 may acquire data on an actual SOC of this battery 11.

Next, the processor 21 of the battery station 20 may transmit data on the battery identifier and the SOC of the battery 11 detached in step S111, to the battery manager 30 (step S112). The communicator 31 of the battery manager 30 may receive the data from the processor 21.

Next, the drop-off processor 37 of the battery manager 30 may perform a drop-off process of the detached battery 11 (step S113). In some embodiments, the drop-off processor 37 may update the management data DT, based on the data received by the communicator 31 in step S112. For example, the drop-off processor 37 may delete the scheduled drop-off date and time and the drop-off vehicle data and set the stock flag to “1”, in the record of the detached battery 11 in the management data DT. This means that the drop-off processor 37 may delete the scheduled drop-off date and time and the drop-off vehicle data and set the stock flag to “1” when the detached battery 11 is stocked in the battery station 20. Further, the drop-off processor 37 may register the data on the actual SOC of the detached battery 11 in this record.

Referring to FIG. 7C, for example, in the operation example E1, the drop-off processor 37 may delete the scheduled drop-off date and time and the drop-off vehicle data and set the stock flag to “1”, in the record of the battery 11 having the battery identifier of “IDB13” and detached from the vehicle 10A. Further, the drop-off processor 37 may register the data on the actual SOC of the detached battery 11 in this record.

Moreover, the vehicle 10A and the processor 21 of the battery station 20 may perform a battery attachment process of attaching the battery 11 to the vehicle 10A in accordance with the operation performed by the staff (step S114).

Next, the processor 21 of the battery station 20 may transmit data on the battery identifier of the battery 11 attached in step S114, to the battery manager 30 (step S115). The communicator 31 of the battery manager 30 may receive the data from the processor 21.

Next, the pick-up processor 38 of the battery manager 30 may perform a pick-up process of the attached battery 11 (step S116). In some embodiments, the pick-up processor 38 may update the management data DT, based on the data received by the communicator 31 in step S115. For example, the pick-up processor 38 may delete the record of the attached battery 11 in the management data DT. The battery 11 attached to the vehicle 10A may be used in the vehicle 10A for a while, and thus may not be used in another vehicle 10. Accordingly, the pick-up processor 38 may delete the record of the battery 11 attached to the vehicle 10A to exclude the battery 11 from the batteries to be managed.

In the operation example E1, for example, the pick-up processor 38 may delete the record of the battery 11 having the battery identifier of “IDB11” and attached to the vehicle 10A (see FIG. 7B), as illustrated in FIG. 7C.

Thereafter, this operation may end.

### Operation Example E2

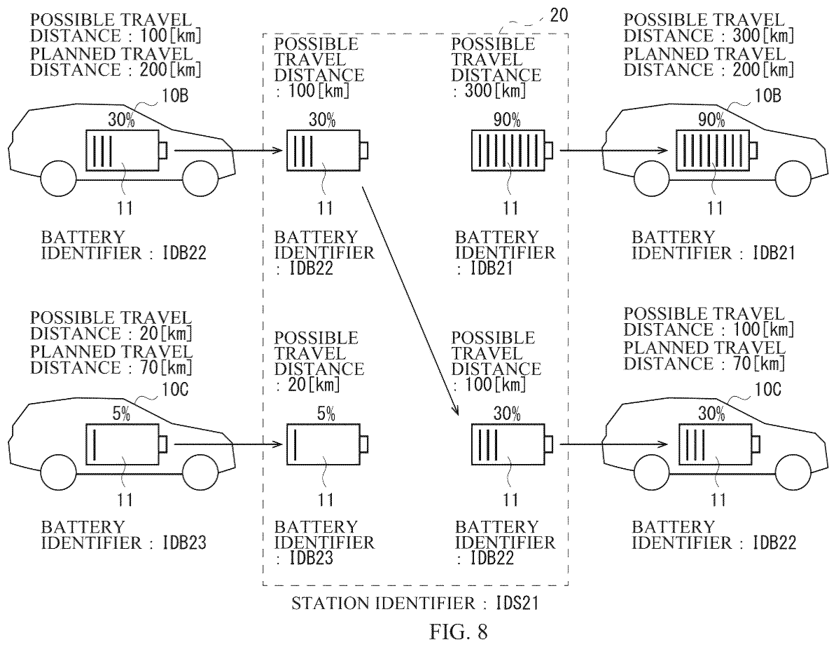

FIG. 8 illustrates an operation example E2 as another operation example of the battery management system 1. In this example, two vehicles 10 (hereinafter, referred to as the “vehicle 10B” and the “vehicle 10C”) may be each traveling on a planned travel route toward a target point. The battery 11 of the vehicle 10B may have a battery identifier of “IDB22”, a remaining SOC of 30%, and a possible travel distance of 100 km. The vehicle 10B may have a planned travel distance to the target point of 200 km. Accordingly, the vehicle 10B may have a difficulty in reaching the target point using the current battery 11. Further, the battery 11 of the vehicle 10C may have a battery identifier of “IDB23”, a remaining SOC of 5%, and a possible travel distance of 20 km. The vehicle 10C may have a planned travel distance to the target point of 70 km. Accordingly, the vehicle 10C may have a difficulty in reaching the target point using the current battery 11.

In this example, the battery station 20 having a station identifier of “IDS21” may be situated on the respective planned travel routes of the vehicle 10B and the vehicle 10C. The battery 11 having a battery identifier of “IDB21” may be stocked in this battery station 20. This battery 11 may have a remaining SOC of 90% and a possible travel distance of 300 km. If the battery 11 currently used in the vehicle 10B is replaced with the battery 11 having the battery identifier of “IDB21” in the battery station 20, the vehicle 10B may be able to reach the target point. The battery 11 having the battery identifier of “IDB22” and detached from the vehicle 10B in this battery replacement may have a remaining SOC of 30% and a possible travel distance of 100 km. If the battery 11 of the vehicle 10C is replaced with the battery 11 detached from the vehicle 10B in the battery station 20, the vehicle 10C may be able to reach the target point.

Hereinafter, the operation of the battery management system 1 in such an example will be described.

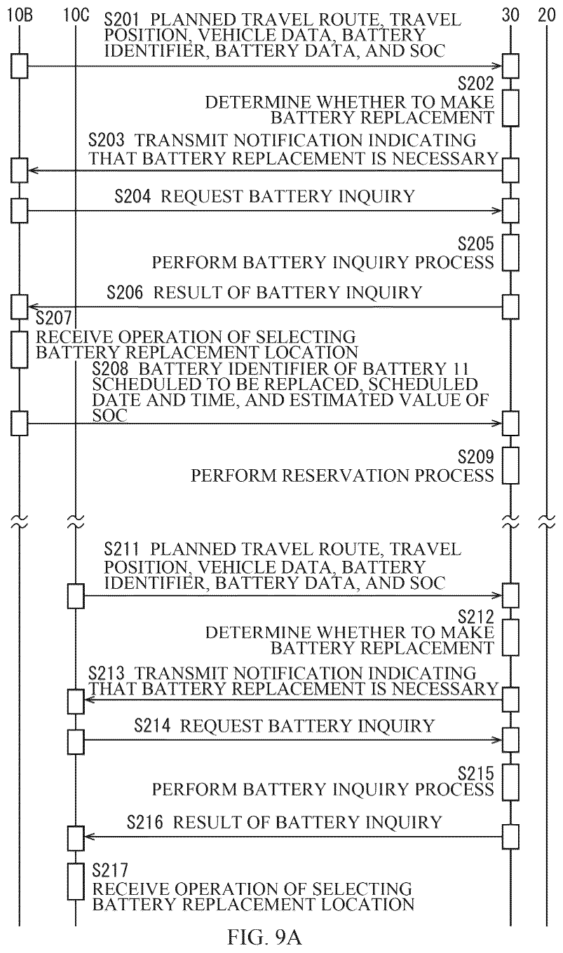

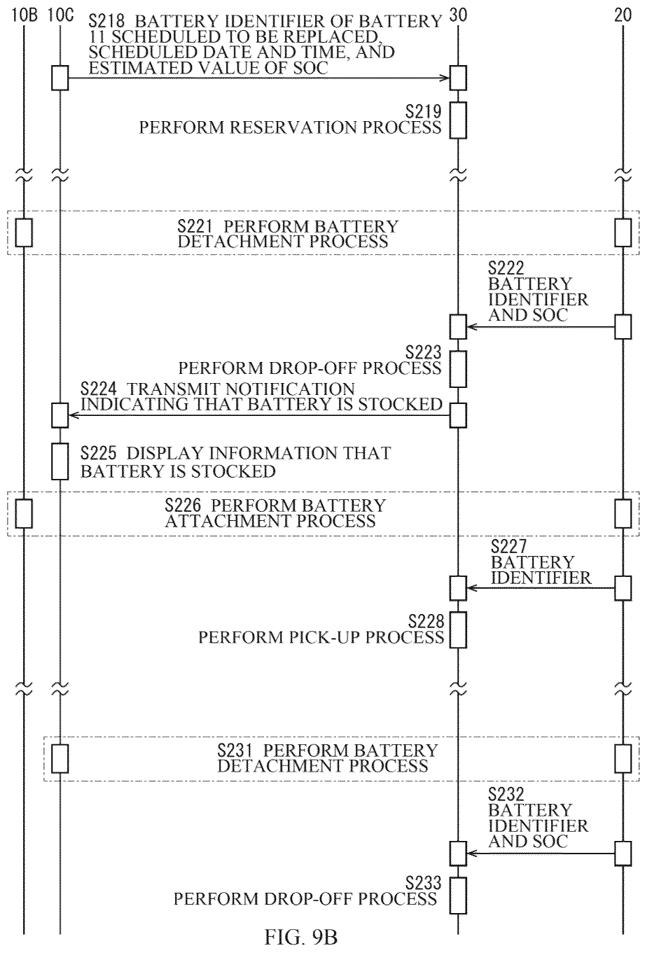

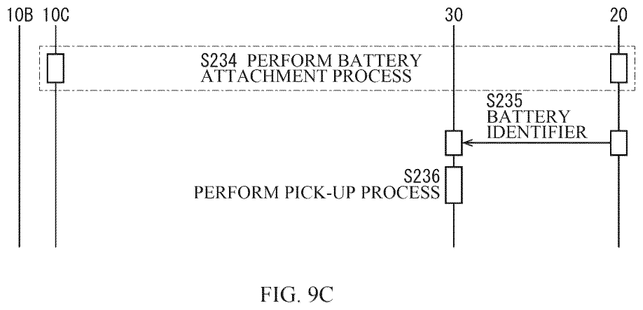

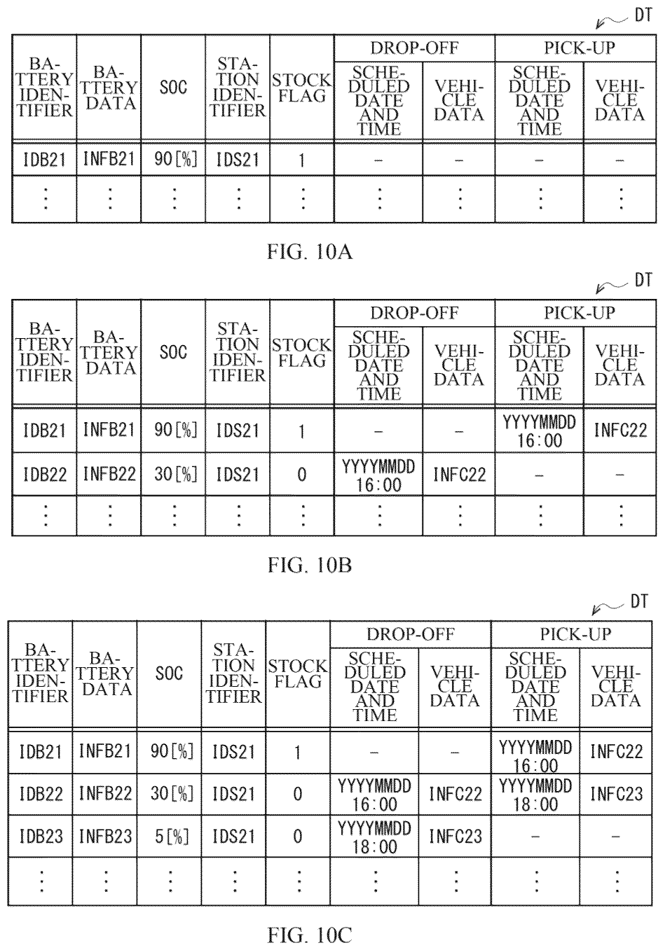

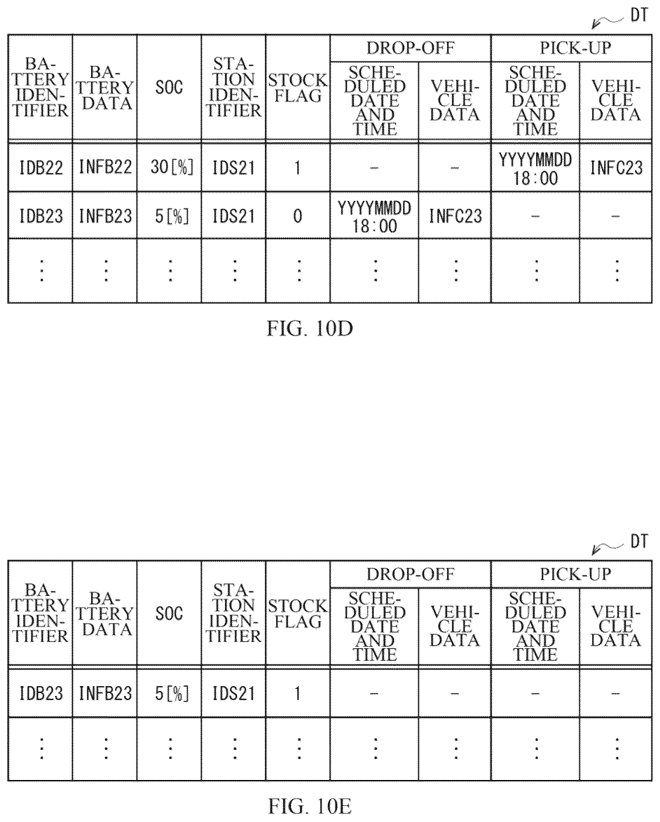

FIGS. 9A to 9C each illustrate an exemplary operation of the battery management system 1 in the operation example E2. FIGS. 10A to 10E each illustrate an example of the management data DT in the operation example E2.

Similarly to the operation example E1, the vehicle 10B may first make a reservation for the battery replacement in steps S201 to S209.

First, the communicator 16 of the vehicle 10B may transmit data including the planned travel route of the vehicle 10B, a current travel position of the traveling vehicle 10B, vehicle data on the vehicle 10B, a battery identifier of the battery 11 attached to the vehicle 10B, battery data on the battery 11 attached to the vehicle 10B, and an SOC of the battery 11 attached to the vehicle 10B, to the battery manager 30 in accordance with an instruction from the processor 18 (step S201).

Next, the replacement determiner 34 of the battery manager 30 may determine whether to make the battery replacement, based on the data received by the communicator 31 (step S202). In the operation example E2 illustrated in FIG. 8, the possible travel distance of the vehicle 10B (100 km) may be shorter than the planned travel distance of the vehicle 10B (200 km). Accordingly, the replacement determiner 34 may determine that the battery replacement is to be made for the vehicle 10B.

Next, the communicator 31 of the battery manager 30 may transmit a notification indicating that the battery replacement is necessary, to the vehicle 10B in accordance with an instruction from the processing unit 33 (step S203).

Next, the communicator 16 of the vehicle 10B may transmit a request for the battery inquiry to the battery manager 30 in accordance with an instruction from the processor 18 (step S204).

Next, the battery inquirer 35 of the battery manager 30 may perform the battery inquiry process (step S205). Referring to FIG. 10A, in the operation example E2, the battery 11 having the battery identifier of “IDB21” may be already stocked in the battery station 20 having the station identifier of “IDS21”, and have an SOC of 90%. This battery station 20 may be situated on the planned travel route of the vehicle 10B.

Next, the communicator 31 of the battery manager 30 may transmit a result of the battery inquiry process in accordance with an instruction from the processing unit 33 (step S206).

Next, the user interface 17 of the vehicle 10B may receive an operation of selecting a battery replacement location in accordance with an instruction from the processor 18 (step S207). In the operation example E2, the driver may perform the selection operation of selecting the battery station 20 having the station identifier of “IDS21” illustrated in FIG. 10A for the replacement of the battery 11. By this selection operation, the battery 11 having the battery identifier of “IDB21” and stocked in the battery station 20 having the station identifier of “IDS21” may be selected as the battery 11 to be used.

Next, the communicator 16 of the vehicle 10B may transmit data on the battery identifier of the selected battery 11, scheduled arrival date and time of the vehicle 10B at the selected battery station 20, and an estimated value of the SOC of the battery 11 being currently used in the vehicle 10B, to the battery manager 30 in accordance with an instruction from the processor 18 (step S208).

Next, the reservation processor 36 of the battery manager 30 may perform the reservation process for the battery replacement (step S209).

Referring to FIG. 10B, for example, in the operation example E2, the reservation processor 36 may register data on scheduled pick-up date and time and pick-up vehicle data for the battery 11 having the battery identifier of “IDB21” and scheduled to be attached to the vehicle 10B, in a record of this battery 11. In this example, the scheduled pick-up date and time may be “YYYYMMDD, 16:00”, and the pick-up vehicle data may be “INFC22”. This vehicle data may be related to the vehicle 10B.

Further, the reservation processor 36 may register a new record of the battery 11 having the battery identifier of “IDB22” and being used in the vehicle 10B, in the management data DT. The battery data on this battery 11 may be “INFB22”. The battery replacement for the vehicle 10B may be to be made in the battery station 20 having the station identifier of “IDS21” in which the battery 11 to be attached to the vehicle 10B is stocked. In this example, the scheduled drop-off date and time may be “YYYYMMDD, 16:00”, and the drop-off vehicle data may be “INFC22”.

In this way, the reservation for the battery replacement for the vehicle 10B may be made in the battery management system 1.

Next, the vehicle 10C may similarly make a reservation for the battery replacement in steps S211 to S219.

First, the communicator 16 of the vehicle 10C may transmit data including the planned travel route of the vehicle 10C, a current travel position of the traveling vehicle 10C, vehicle data on the vehicle 10C, a battery identifier of the battery 11 attached to the vehicle 10C, battery data on the battery 11 attached to the vehicle 10C, and an SOC of the battery 11 attached to the vehicle 10C, to the battery manager 30 in accordance with an instruction from the processor 18 (step S211).

Next, the replacement determiner 34 of the battery manager 30 may determine whether to make the battery replacement, based on the data received by the communicator 31 (step S212). In the operation example E2 illustrated in FIG. 8, the possible travel distance of the vehicle 10C (20 km) may be shorter than the planned travel distance of the vehicle 10C (70 km). Accordingly, the replacement determiner 34 may determine that the battery replacement is to be made for the vehicle 10C.

Next, the communicator 31 of the battery manager 30 may transmit a notification indicating that the battery replacement is necessary, to the vehicle 10C in accordance with an instruction from the processing unit 33 (step S213).

Next, the communicator 16 of the vehicle 10C may transmit a request for the battery inquiry to the battery manager 30 in accordance with an instruction from the processor 18 (step S214).

Next, the battery inquirer 35 of the battery manager 30 may perform the battery inquiry process (step S215). Referring to FIG. 10B, in the operation example E2, the battery 11 having the battery identifier of “IDB22” may be usable. For example, the battery 11 having the battery identifier of “IDB22” may be scheduled to be stocked in the battery station 20 having the station identifier of “IDS21” on the scheduled date at 16:00, and have an SOC of 30%. Although the SOC of this battery 11 is not so high, the possible travel distance of the battery 11 (100 km) may be sufficiently longer than the planned travel distance of the vehicle 10C (20 km). Accordingly, this battery 11 may be usable in the vehicle 10C. Note that the vehicle 10C is not able to make the reservation for the use of the battery 11 having the battery identifier of “IDB21” that has been already reserved and is scheduled to be picked up on the same scheduled date.

Next, the communicator 31 of the battery manager 30 may transmit a result of the battery inquiry process in accordance with an instruction from the processing unit 33 (step S216).

Next, the user interface 17 of the vehicle 10C may receive an operation of selecting a battery replacement location in accordance with an instruction from the processor 18 (step S217). In the operation example E2, the driver may perform the selection operation of selecting the battery station 20 having the station identifier of “IDS21” illustrated in FIG. 10B for the replacement of the battery 11. By this selection operation, the battery 11 having the battery identifier of “IDB22” and scheduled to be stocked in the battery station 20 having the station identifier of “IDS21” on the scheduled date at 16:00 may be selected as the battery 11 to be used.

Next, the communicator 16 of the vehicle 10C may transmit data on the battery identifier of the selected battery 11, scheduled arrival date and time of the vehicle 10C at the selected battery station 20, and an estimated value of the SOC of the battery 11 being currently used in the vehicle 10C, to the battery manager 30 in accordance with an instruction from the processor 18 (step S218).

Next, the reservation processor 36 of the battery manager 30 may perform the reservation process for the battery replacement (step S219).

Referring to FIG. 10C, for example, in the operation example E2, the reservation processor 36 may register data on scheduled pick-up date and time and pick-up vehicle data for the battery 11 having the battery identifier of “IDB22” and scheduled to be attached to the vehicle 10C, in the record of this battery 11. In this example, the scheduled pick-up date and time may be “YYYYMMDD, 18:00”, and the pick-up vehicle data may be “INFC23”. This vehicle data may be related to the vehicle 10C.

Further, the reservation processor 36 may register a new record of the battery 11 having the battery identifier of “IDB23” and being used in the vehicle 10C, in the management data DT. The battery data on this battery 11 may be “INFB23”. The battery replacement for the vehicle 10C may be to be made in the battery station 20 having the station identifier of “IDS21” in which the battery 11 to be attached to the vehicle 10C is stocked. In this example, the scheduled drop-off date and time may be “YYYYMMDD, 18:00”, and the drop-off vehicle data may be “INFC23”.

In this way, the reservation for the battery replacement for the vehicle 10C may be made in the battery management system 1.

Thereafter, the vehicle 10B may arrive at the battery station 20 having the station identifier of “IDS21” around 16:00 as scheduled. Then, the battery replacement for the vehicle 10B may be made in steps S221 to S228.

In the battery station 20, for example, staff may operate the vehicle 10B and the processor 21 of the battery station 20. In accordance with the operation performed by the staff, the vehicle 10B and the processor 21 of the battery station 20 may perform the battery detachment process of detaching the battery 11 from the vehicle 10B (step S221). In this process, the processor 21 may acquire data on an actual SOC of this battery 11.

Next, the processor 21 of the battery station 20 may transmit data on the battery identifier and the SOC of the battery 11 detached in step S221, to the battery manager 30 (step S222).

Next, the drop-off processor 37 of the battery manager 30 may perform the drop-off process of the detached battery 11 (step S223). Referring to FIG. 10D, in the operation example E2, the drop-off processor 37 may delete the scheduled drop-off date and time and the drop-off vehicle data and set the stock flag to “1”, in the record of the battery 11 having the battery identifier of “IDB22” and detached from the vehicle 10B. Further, the drop-off processor 37 may register the data on the actual SOC of the detached battery 11 in this record.

Next, the communicator 31 of the battery manager 30 may transmit a notification indicating that the battery 11 is stocked, to the vehicle 10C in accordance with an instruction from the processing unit 33 (step S224). The communicator 16 of the vehicle 10C may receive the notification from the communicator 31.

Next, the user interface 17 of the vehicle 10C may display information that the battery 11 scheduled to be attached in the battery station 20 is stocked, in accordance with an instruction from the processor 18 (step S225). Such display may allow the driver of the vehicle 10C to confirm that the battery 11 is replaceable in the battery station 20.

Moreover, the vehicle 10B and the processor 21 of the battery station 20 may perform the battery attachment process of attaching the battery 11 to the vehicle 10B in accordance with the operation performed by the staff (step S226).

Next, the processor 21 of the battery station 20 may transmit data on the battery identifier of the battery 11 attached in step S226, to the battery manager 30 (step S227).

Next, the pick-up processor 38 of the battery manager 30 may perform the pick-up process of the attached battery 11 (step S228). Referring to FIG. 10D, in the operation example E2, the pick-up processor 38 may delete the record of the battery 11 having the battery identifier of “IDB21” and attached to the vehicle 10B (see FIG. 10C).

Thereafter, the vehicle 10C may arrive at the battery station 20 having the station identifier of “IDS2” around 18:00 as scheduled. Then, the battery replacement for the vehicle 10C may be made in steps S231 to S236.

In the battery station 20, for example, the staff may operate the vehicle 10C and the processor 21 of the battery station 20. In accordance with the operation performed by the staff, the vehicle 10C and the processor 21 of the battery station 20 may perform the battery detachment process of detaching the battery 11 from the vehicle 10C (step S231). In this process, the processor 21 may acquire data on an actual SOC of this battery 11.

Next, the processor 21 of the battery station 20 may transmit data on the battery identifier and the SOC of the battery 11 detached in step S231, to the battery manager 30 (step S232).

Next, the drop-off processor 37 of the battery manager 30 may perform the drop-off process of the detached battery 11 (step S233). Referring to FIG. 10E, in the operation example E2, the drop-off processor 37 may delete the scheduled drop-off date and time and the drop-off vehicle data and set the stock flag to “1”, in the record of the battery 11 having the battery identifier of “IDB23” and detached from the vehicle 10C. Further, the drop-off processor 37 may register data on the actual SOC of the detached battery 11 in this record.

Moreover, the vehicle 10C and the processor 21 of the battery station 20 may perform the battery attachment process of attaching the battery 11 to the vehicle 10C in accordance with the operation performed by the staff (step S234).

Next, the processor 21 of the battery station 20 may transmit data on the battery identifier of the battery 11 attached in step S234, to the battery manager 30 (step S235).

Next, the pick-up processor 38 of the battery manager 30 may perform the pick-up process of the attached battery 11 (step S236). Referring to FIG. 10E, in the operation example E2, the pick-up processor 38 may delete the record of the battery 11 having the battery identifier of “IDB22” and attached to the vehicle 10C (see FIG. 10D).

Thereafter, this operation may end.

In one embodiment, the vehicle 10B may serve as the “first vehicle”. In one embodiment, the vehicle 10C may serve as the “second vehicle”. In one embodiment, the battery 11 having the battery identifier of “IDB22” may serve as the “first battery”. In one embodiment, the battery 11 having the battery identifier of “IDB23” may serve as the “second battery”.

As described above, the battery manager 30 includes the processing circuitry (the processing unit 33) and the communication circuitry (the communicator 31). The processing circuitry is configured to manage the data on the multiple batteries 11 to be used in the battery-replaceable vehicles 10. The processing circuitry is configured to determine whether the first battery of the first vehicle (e.g., the vehicle 10B) scheduled for the battery replacement in the first battery station is usable in the second vehicle, based on a remaining SOC of the first battery before the battery replacement. When the first battery is usable in the second vehicle (e.g., the vehicle 10C), the communication circuitry is configured to transmit, to the second vehicle, a notification indicating that the second battery of the second vehicle (e.g., the vehicle 10C) is replaceable with the first battery in the first battery station. Such a configuration helps to, for example, eliminate necessity of stocking the battery 11 usable in the vehicle 10C in the battery station 20, allowing the battery 11 having been used in the vehicle 10B until immediately prior to the battery replacement to be used by the vehicle 10C, for example. This helps to shorten a dwell time of the battery 11 in the battery station 20.

Meanwhile, one conceivable approach involves storing in advance a large number of batteries 11 in the battery station 20 to thereby prepare for a reservation for the battery replacement. This approach, however, can increase the dwell time of the batteries 11 in the battery station 20. For example, a long dwell time of the large number of batteries 11 can necessitate time and effort taken by, for example, the staff of the battery station 20 to manage the large number of batteries 11. Such a long dwell time can also necessitate accommodating the large number of batteries 11, making the battery station 20 a larger facility.

In contrast, the battery manager 30, for example, allows the battery 11 having been used in the vehicle 10B, for example, until immediately prior to the battery replacement to be used by the vehicle 10C, shortening the dwell time of the battery 11 in the battery station 20. This helps to decrease the number of the batteries 11 to be stocked in the battery station 20, resulting in less time and effort taken by the staff of the battery station 20. Such a short dwell time also helps to decrease the number of the batteries 11 to be stocked in the battery station 20, making the battery station 20 a smaller facility.

Further, in the battery management system 1 including the battery manager 30, the battery 11 to be picked up may not necessarily be fully charged. Such a configuration helps to eliminate time to fully charge the battery 11 in each battery station 20, shortening the dwell time of the battery 11 in the battery station 20. Not being necessarily fully charged as described above, the battery 11 is subjected to a decreased number of times of charging. This prolongs the lifetime of the battery 11. Note that picking up of the battery 11 that is not necessarily fully charged can be a slight inconvenience for the driver. In this case, for example, the driver who has picked up such a battery 11 in the replacement may be given an incentive such as point addition. The driver may receive various kinds of services by using accumulated points.

Furthermore, when the first battery is usable in the second vehicle (e.g., the vehicle 10C), the communication circuitry (the communicator 31) of the battery manager 30 is configured to transmit, to the second vehicle (e.g., the vehicle 10C), the notification indicating that the second battery is replaceable with the first battery in the first battery station. Such a configuration allows the driver of the vehicle 10C to grasp that the battery replacement is possible in the first battery station. This reassures the driver who is driving the vehicle 10C.

In some embodiments, the processing circuitry (the processing unit 33) of the battery manager 30 may be configured to determine whether the first battery is usable in the second vehicle (e.g., the vehicle 10C), based on the remaining SOC of the first battery and a remaining planned travel distance on a planned travel route of the second vehicle (e.g., the vehicle 10C). Such a configuration helps the processing unit 33 to make a more highly accurate determination as to whether the battery 11 is usable in the vehicle 10C, even when the remaining SOC of the battery 11 of the vehicle 10B is low before the battery replacement.

In some embodiments, the processing circuitry (the processing unit 33) of the battery manager 30 may be configured to determine whether the second vehicle (e.g., the vehicle 10C) is able to reach a target point, based on a remaining SOC of the second battery and the remaining planned travel distance on the planed travel route of the second vehicle (e.g., the vehicle 10C). When the second vehicle (e.g., the vehicle 10C) has a difficulty in reaching the target point, the processing circuitry may be configured to determine whether the first battery is usable in the second vehicle (e.g., the vehicle 10C). Such a configuration of the battery manager 30 helps to suggest the battery replacement to the driver of the vehicle 10C, when it is determined that the battery replacement for the vehicle 10C is necessary based on a remaining SOC of the battery 11 of the vehicle 10C. This reassures the driver who is driving the vehicle 10C.

In some embodiments, the multiple batteries 11 to be managed by the battery manager 30 may include a battery already stocked in the first battery station and a battery scheduled to be stocked in the first battery station. This helps the battery manager 30 to suggest, for example, the replacement with the battery 11 already stocked in the first battery station and fully charged and the replacement with the battery 11 of the first vehicle (e.g., the vehicle 10B) used prior to the battery replacement for the first vehicle, to the driver of the second vehicle (e.g., the vehicle 10C). Such a configuration allows the driver to select the replacement with an appropriate battery 11 depending on a travel plan following arrival at the target point.

### Example Effects

In the foregoing example embodiment, the battery manager includes the processing circuitry and the communication circuitry. The processing circuitry is configured to manage data on multiple batteries to be used in battery-replaceable vehicles. The multiple batteries include the first battery and the second battery. The battery-replaceable vehicles include the first vehicle and the second vehicle to each of which the battery manager is to be applied. The processing circuitry is configured to determine whether the first battery of the first vehicle scheduled for the battery replacement in the first battery station is usable in the second vehicle, based on the remaining SOC of the first battery before the battery replacement. When the first battery is usable in the second vehicle, the communication circuitry is configured to transmit, to the second vehicle, the notification indicating that the second battery of the second vehicle is replaceable with the first battery in the first battery station. Such a configuration helps to shorten the dwell time of the batteries in the battery station.

In some embodiments, the processing circuitry may be configured to determine whether the first battery is usable in the second vehicle, based on the remaining SOC of the first battery and the remaining planned travel distance on the planned travel route of the second vehicle. Such a configuration enables a more highly accurate determination as to whether the battery is usable in the vehicle.

In some embodiments, the processing circuitry may be configured to determine whether the second vehicle is able to reach the target point, based on the remaining SOC of the second battery and the remaining planned travel distance on the planned travel route of the second vehicle. When the second vehicle has a difficulty in reaching the target point, the processing circuitry may be configured to determine whether the first battery is usable in the second vehicle. Such a configuration helps to suggest the battery replacement to the driver when the battery replacement is necessary.

In some embodiments, the multiple batteries include the battery already stocked in the first battery station and the battery scheduled to be stocked in the first battery station. Such a configuration helps to suggest, for example, the replacement with the battery already stocked in the first battery station and fully charged and the replacement with the battery of the first vehicle used prior to the battery replacement for the first vehicle, to the driver of the second vehicle.

### Modification Example 1

According to the foregoing example embodiment, the vehicle 10C may pick up the battery 11 having been used in the vehicle 10B as-is in the battery station 20, as illustrated in FIG. 8; however, this is a non-limiting example. In some embodiments, the battery 11 having been used in the vehicle 10B may be charged in the battery station 20, and the vehicle 10C may pick up the charged battery 11 in the battery station 20.

### Modification Example 2

According to the foregoing example embodiment, in the operation example E2, the battery replacement for the vehicle 10B and the vehicle 10C may be made in the battery station 20 selected by the driver of the vehicle 10B; however, this is a non-limiting example. In some embodiments, the battery station 20 for the battery replacement may be changeable. For example, the change of the battery station 20 may be made based on traffic conditions around the battery station 20 scheduled for the battery replacement, or in accordance with a request from the vehicle 10C.

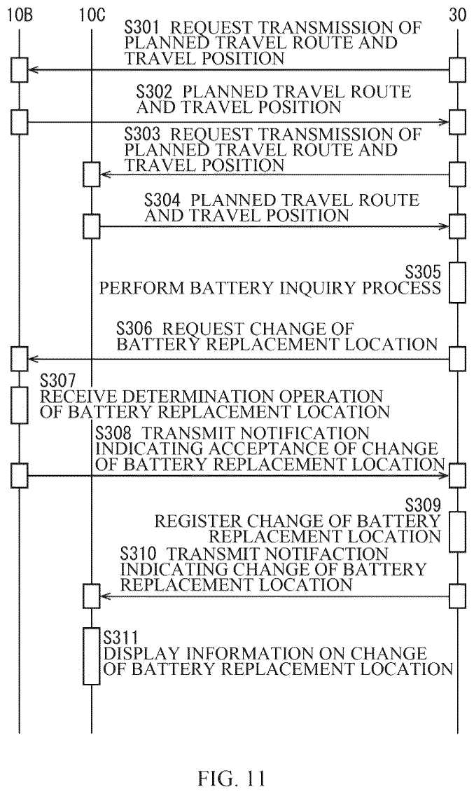

FIG. 11 illustrates an operation example of the battery management system 1 according to Modification Example 2. The operation of the battery management system 1 may be performed after the respective reservations made by the vehicle 10B and vehicle 10C for the battery replacement.

First, the communicator 31 of the battery manager 30 may transmit a request for transmission of the planned travel route and the travel position of the vehicle 10B, to the vehicle 10B in accordance with an instruction from the processing unit 33 (step S301). The communicator 16 of the vehicle 10B may receive the transmission request from the communicator 31.

Next, the communicator 16 of the vehicle 10B may transmit data on the planned travel route and the travel position of the vehicle 10B, to the battery manager 30 in accordance with an instruction from the processor 18 (step S302). The communicator 31 of the battery manager 30 may receive the data from the communicator 16.

Next, the communicator 31 of the battery manager 30 may transmit a request for transmission of the planned travel route and the travel position of the vehicle 10C, to the vehicle 10C in accordance with an instruction from the processing unit 33 (step S303). The communicator 16 of the vehicle 10C may receive the transmission request from the communicator 31.

Next, the communicator 16 of the vehicle 10C may transmit data on the planned travel route and the travel position of the vehicle 10C, to the battery manager 30 in accordance with an instruction from the processor 18 (step S304). The communicator 31 of the battery manager 30 may receive the data from the communicator 16.

Next, the battery inquirer 35 of the battery manager 30 may perform the battery inquiry process, based on the management data DT (step S305). In some embodiments, the battery inquirer 35 may search the multiple battery stations 20 situated on the respective planned travel routes of the vehicle 10B and the vehicle 10C for the battery 11 usable in the vehicle 10B, based on the management data DT. In some embodiments, the usable battery 11 may be the battery 11 already stocked in the battery station 20. In some embodiments, the usable battery 11 may be the battery 11 scheduled to be stocked in the battery station 20 after being used in another vehicle 10.

Next, the communicator 31 of the battery manager 30 transmits a request for a change of the battery replacement location in accordance with an instruction from the processing unit 33 (step S306). In some embodiments, the communicator 31 may transmit the data inquired in step S305, including data on the battery 11 usable in the vehicle 10B and data on the battery station 20 for the replacement with this battery 11, and also transmit the request for the change of the battery replacement location. The communicator 16 of the vehicle 10B may receive the data from the communicator 31.

Next, the user interface 17 of the vehicle 10B may receive an operation of determining the change of the battery replacement location in accordance with an instruction from the processor 18 (step S307). In some embodiments, the user interface 17 may display the data received by the communicator 16, including the data on the battery station 20 and the data on the usable battery 11. For example, the driver may perform the operation of determining the change of the battery replacement location, based on content displayed on the user interface 17. The user interface 17 may receive the determination operation performed by the driver.

Next, the communicator 16 of the vehicle 10B may transmit a notification indicating acceptance of the change of the battery station 20, to the battery manager 30 in accordance with an instruction from the processor 18 (step S308). The communicator 31 of the battery manager 30 receives the notification from the communicator 16.

Next, the reservation processor 36 of the battery manager 30 may register the change of the battery replacement location in the management data DT (step S309). In some embodiments, the reservation processor 36 may update the record, inquired in step S305, of the battery 11 scheduled to be used in the vehicle 10B, the record of the battery 11 scheduled to be detached from the vehicle 10B and be used in the vehicle 10C, and the record of the battery 11 to be detached from the vehicle 10B, in the management data DT.

Next, the communicator 31 of the battery manager 30 transmits a notification indicating the change of the battery replacement location, to the vehicle 10C in accordance with an instruction from the processing unit 33 (step S310). The communicator 16 of the vehicle 10C may receive the notification from the communicator 31.

Thereafter, the user interface 17 of the vehicle 10C may display information on the change of the battery replacement location in accordance with an instruction from the processor 18 (step S311).

Thereafter, this operation may end.

In the battery manager 30 according to the present modification example, the processing circuitry (the processing unit 33) is further configured to check whether a second battery station is available for the battery replacement for the first vehicle (e.g., the vehicle 10B). When the second battery station is available, the communication circuitry (the communicator 31) is configured to: request the first vehicle (e.g., the vehicle 10B) to change the battery replacement location from the first battery station to the second battery station; and receive a notification indicating acceptance of changing the battery replacement location from the first vehicle (e.g., the vehicle 10B). When receiving the notification indicating the acceptance of changing the battery replacement location from the first vehicle (e.g., the vehicle 10B), the communication circuitry (the communicator 31) is configured to transmit, to the second vehicle (e.g., the vehicle 10C), a notification indicating that the second battery is replaceable with the first battery in the second battery station. Such a configuration of the battery manager 30 allows for the change of the battery replacement location. Such a change of the battery replacement location allows the battery replacement to be made even in a case of unexpected inconvenience, for example.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

For example, the foregoing example embodiment may use the management data DT illustrated in FIG. 4; however, this is a non-limiting example. In some embodiments, a part of data included in the management data DT may not be provided. In one example, any other kind of data may be provided in the management data DT.

For example, the processing sequences illustrated in FIGS. 6 and 9A to 9C in the foregoing example embodiment may be merely exemplary. In some embodiments, a processing sequence different from these processing sequences may be used.

The example effects described herein are mere exemplary, and example effects of any embodiment of the disclosure are therefore not limited to those described herein. Accordingly, any embodiment of the disclosure may achieve any other example effects.

At least the following configurations are achievable from the foregoing example embodiment and its modification examples of the disclosure.
(1) A battery manager including:
   processing circuitry configured to manage data on multiple batteries to be used in battery-replaceable vehicles, the multiple batteries including a first battery and a second battery, the battery-replaceable vehicles including a first vehicle and a second vehicle to each of which the battery manager is to be applied, the processing circuitry being configured to determine whether the first battery of the first vehicle scheduled for battery replacement in a first battery station is usable in the second vehicle, based on a remaining state of charge of the first battery before the battery replacement; and
   communication circuitry configured to transmit, to the second vehicle, a notification indicating that the second battery of the second vehicle is replaceable with the first battery in the first battery station, when the first battery is usable in the second vehicle.
(2) The battery manager according to (1), in which the processing circuitry is configured to determine whether the first battery is usable in the second vehicle, based on the remaining state of charge of the first battery and a remaining planned travel distance on a planned travel route of the second vehicle.
(3) The battery manager according to (1) or (2), in which
   the processing circuitry is configured to determine whether the second vehicle is able to reach a target point, based on a remaining state of charge of the second battery and a remaining planned travel distance on a planned travel route of the second vehicle, and
   when the second vehicle is determined to have a difficulty in reaching the target point, the processing circuitry is configured to determine whether the first battery is usable in the second vehicle.
(4) The battery manager according to any one of (1) to (3), in which the multiple batteries include a battery already stocked in the first battery station and a battery scheduled to be stocked in the first battery station.
(5) The battery manager according to any one of (1) to (4), in which
   the processing circuitry is further configured to check whether a second battery station is available for the battery replacement for the first vehicle,
   when the second battery station is available, the communication circuitry is configured to request the first vehicle to change a battery replacement location from the first battery station to the second battery station,
   the communication circuitry is configured to receive a notification indicating acceptance of changing the battery replacement location from the first vehicle, and
   when receiving the notification indicating the acceptance of changing the battery replacement location from the first vehicle, the communication circuitry is configured to transmit, to the second vehicle, a notification indicating that the second battery is replaceable with the first battery in the second battery station.

Each of the communicator 31 and the processing unit 33 illustrated in FIG. 3 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the communicator 31 and the processing unit 33 illustrated in FIG. 3. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the communicator 31 and the processing unit 33 illustrated in FIG. 3.

1. A battery manager comprising:
processing circuitry configured to manage data on batteries to be used in battery-replaceable vehicles, the batteries comprising a first battery and a second battery, the battery-replaceable vehicles comprising a first vehicle and a second vehicle to each of which the battery manager is to be applied, the processing circuitry being configured to determine whether the first battery of the first vehicle scheduled for battery replacement in a first battery station is usable in the second vehicle, based on a remaining state of charge of the first battery before the battery replacement; and
communication circuitry configured to transmit, to the second vehicle, a notification indicating that the second battery of the second vehicle is replaceable with the first battery in the first battery station, when the first battery is usable in the second vehicle, wherein
the processing circuitry is further configured to check whether a second battery station is available for the battery replacement for the first vehicle,
when the second battery station is available, the communication circuitry is configured to request the first vehicle to change a battery replacement location from the first battery station to the second battery station,
the communication circuitry is configured to receive a notification indicating acceptance of changing the battery replacement location from the first vehicle, and
when receiving the notification indicating the acceptance of changing the battery replacement location from the first vehicle, the communication circuitry is configured to transmit, to the second vehicle, a notification indicating that the second battery is replaceable with the first battery in the second battery station.

2. The battery manager according to claim 1, wherein the processing circuitry is configured to determine whether the first battery is usable in the second vehicle, based on the remaining state of charge of the first battery and a remaining planned travel distance on a planned travel route of the second vehicle.

3. The battery manager according to claim 1, wherein
the processing circuitry is configured to determine whether the second vehicle is able to reach a target point, based on a remaining state of charge of the second battery and a remaining planned travel distance on a planned travel route of the second vehicle, and
when the second vehicle is determined to have a difficulty in reaching the target point, the processing circuitry is configured to determine whether the first battery is usable in the second vehicle.

4. The battery manager according to claim 1, wherein the batteries comprise a battery already stocked in the first battery station and a battery scheduled to be stocked in the first battery station.
